(19) United States
(12) Patent Application Publication
(10) Pub. No.: US 2016/0027131 A1
(43) Pub. Date: Jan. 28, 2016

(54) SYSTEM AND METHOD FOR PROJECTING AN INTERACTIVE IMAGE AND PROCESSING USER INTERACTION

(71) Applicant: Cognizant Technology Solutions India Pvt. Ltd, Chennai (IN)

(72) Inventor: Vladislav Vilensky, Seal Beach, CA (US)

(21) Appl. No.: 14/536,890

(22) Filed: Nov. 10, 2014

(30) Foreign Application Priority Data
Jul. 28, 2014 (IN) 3678/CHE/2014

(51) Int. Cl. G06Q 50/12; G06Q 30/06; G06F 3/03; G06K 9/00; G06F 3/01

(52) U.S. Cl. CPC G06Q 50/12; G06K 9/00335; G06F 3/017; G06F 3/0304; G06Q 30/0641; G06Q 30/0635

(57) ABSTRACT

A computer-implemented method and system for projecting one or more interactive images and processing user interaction with the one or more interactive images is provided. The computer-implemented method comprises projecting one or more interactive images on a surface of one or more tables. The computer-implemented method further comprises capturing a plurality of projected interactive images. Furthermore, the computer-implemented method comprises detecting user interaction by comparing a captured image with a subsequently captured image. In addition, the computer-implemented method comprises triggering one or more actions associated with the detected user interaction.

### FIELD OF THE INVENTION

The present invention relates generally to projecting interactive images. More particularly, the present invention provides a method and system for projecting interactive images and processing user response and gestures.

### BACKGROUND OF THE INVENTION

Commercial establishments like restaurants typically involve processes like selecting food and beverages of choice from a menu provided, placing orders for the selected food and beverages to a waiter or attendant, the waiter taking the order of the customer to the kitchen for its delivery to the customer's table, and the customer making payment for the ordered items.

With increase in number of customers visiting the restaurants, there is often a delay in the service by the waiters or attendants. Also, quality of the food items prepared by the kitchen worsens as a large number of orders are required to be served in short time. Therefore, many restaurants are adopting alternate solutions for manually placing of orders and receiving deliveries.

One of the alternate solutions is to provide an electronic communication device on customers' table that displays menu on a screen and help customers to select the food items of their choice. The customers can then place their order of selected food item directly to the kitchen management system via a communication link. An example of such an electronic communication device is an electronic tablet device that can communicate with the kitchen management system through a wireless network, such as Wi-Fi.

However, the above mentioned solution is not feasible because the electronic communication devices are quite expensive and can increase the overall operations cost for the restaurant. Also these devices can be manhandled by customers especially children, and can therefore result in increased maintenance cost. Further, since these electronic communication devices are very expensive and extremely useful to any individual, there is a chance that these devices might get stolen thereby causing pecuniary loss to the restaurant.

Another alternate solution is to embed a touch screen user interface into each table top that can be used by the customers for placing their orders and making the payment after dining. But the tables embedded with touch screen are also very costly, difficult to maintain, and are prone to manhandling and damages.

In light of the above, there is a need for a system and method that eliminates the need of manually placing the orders in a restaurant. Further, there is a need for a system and method that provides a virtual menu on the table of a customer that is interactive, cost effective, and easy to maintain. Furthermore, there is a need for a system and method for accurately projecting one or more interactive images and processing user response and gestures.

### SUMMARY OF THE INVENTION

A system and computer-implemented method for projecting one or more interactive images and processing user interaction with the one or more interactive images is provided. The system comprises a projector configured to project one or more interactive images on a surface of one or more tables. The system further comprises a camera configured to sequentially capture a plurality of projected interactive images. Furthermore, the system comprises a processing module configured to detect user interaction by comparing a captured image with a subsequently captured image and further configured to trigger one or more actions associated with the detected user interaction.

In an embodiment of the present invention, the system further comprises an overhead delivery unit configured to maneuver one or more central projecting devices to the one or more tables, wherein each of the one or more central projecting devices includes the projector, the camera and the processing module and one or more inverted telescopic tube assemblies configured to accurately position the one or more maneuvered central projecting devices over the surface of the one or more tables.

In an embodiment of the present invention, the one or more actions associated with the detected user interaction comprise at least one of: projecting a new interactive image, sending a trigger to a kitchen management system for placing an order and communicating with one or more external systems. In an embodiment of the present invention, projecting the one or more interactive images on the surface of the one or more tables comprises projecting, on the surface of the one or more tables, a blank image with thin outer boundary, wherein the thin outer boundary has predetermined values of one or more parameters. Further, projecting the one or more interactive images on the surface of the one or more tables comprises capturing the projected blank image by the camera. Furthermore, projecting the one or more interactive images on the surface of the one or more tables comprises locating center of the captured blank image. In addition, projecting the one or more interactive images on the surface of the one or more tables comprises positioning origin of a first coordinate system at the bottom left corner of the captured image. Also, projecting the one or more interactive images on the surface of the one or more tables comprises sampling a circle having center as the center of the captured blank image, wherein sampling comprises determining values of one or more parameters of points forming circumference of the circle. Further, projecting the one or more interactive images on the surface of the one or more tables comprises determining if one or more points on the circumference of the circle coincide with the thin outer boundary, wherein if none of the points coincide with the thin outer boundary then another circle having incremented radius is sampled else coordinates of one or more points on the circumference of the circle that coincide with the thin outer boundary are determined with respect to the first coordinate system and then another circle of incremented radius is sampled. Furthermore, projecting the one or more interactive images on the surface of the one or more tables comprises sampling the subsequent circle having center as the center of the captured blank image, wherein sampling comprises determining values of one or more parameters of points forming circumference of the subsequent circle. In addition, projecting the one or more interactive images on the surface of the one or more tables comprises determining coordinates of one or more points on the circumference of the subsequent circle that coincide with the thin outer boundary. Further, projecting the one or more interactive images on the surface of the one or more tables comprises determining coordinates of all the points forming the thin outer boundary by sampling plurality of circles with incremented radiuses having center as the center of the captured blank image. Furthermore, projecting the one or more interactive images on the surface of the one or more tables comprises aligning an application coordinate system with the first coordinate system by positioning origin of the application coordinate system at the bottom left corner of projection boundary formed using the determined coordinates. In addition, projecting the one or more interactive images on the surface of the one or more tables comprises projecting one or more interactive User Interface (UI) elements and non-interactive areas within the projection boundary with respect to the aligned application coordinate system.

In an embodiment of the present invention, the placement and shape of the one or more interactive UI elements and non-interactive areas are pre-stored as at least one of: mathematical equations and solution boundaries with respect to the application coordinate system. In an embodiment of the present invention, the values of the determined one or more parameters of each point forming circumference of the circle are compared with the corresponding predetermined values of one or more parameters of the thin outer boundary for determining if the one or more points on the circumference of the circle coincide with the thin outer boundary.

In an embodiment of the present invention, the values of the determined one or more parameters of each point forming the circumference of the subsequent circle are compared with the corresponding predetermined one or more parameters of the thin outer boundary of the projected blank image for determining the one or more points on the circumference of the subsequent circle that coincide with the thin outer boundary. In an embodiment of the present invention, the one or more parameters comprise at least one of: color, brightness and intensity. In an embodiment of the present invention, the radiuses of the plurality of circles being sampled are incremented by one pixel.

In an embodiment of the present invention, the one or more interactive UI elements are areas within the one or more projected interactive image configured to provide one or more options to one or more users for interacting with the projected interactive image using one or more hand gestures and trigger the one or more actions related to the one or more interactive UI elements.

In an embodiment of the present invention, detecting user interaction by comparing a captured image with a subsequently captured image comprises capturing an image of the projected interactive image using the camera. Further, detecting user interaction by comparing a captured image with a subsequently captured image comprises identifying each of the one or more interactive UI elements within the captured image. Furthermore, detecting user interaction by comparing a captured image with a subsequently captured image comprises segmenting each of the identified one or more interactive UI elements into one or more pixels. In addition, detecting user interaction by comparing a captured image with a subsequently captured image comprises determining values of one or more parameters of the one or more pixels associated with the first captured image. Also, detecting user interaction by comparing a captured image with a subsequently captured image comprises capturing another image of the projected interactive image. Further, detecting user interaction by comparing a captured image with a subsequently captured image comprises identifying each of the one or more interactive UI elements within the subsequently captured image. Furthermore, detecting user interaction by comparing a captured image with a subsequently captured image comprises segmenting each of the identified one or more interactive UI elements into one or more pixels. Also, detecting user interaction by comparing a captured image with a subsequently captured image comprises determining values of one or more parameters of the one or more pixels associated with the subsequently captured image. In addition, detecting user interaction by comparing a captured image with a subsequently captured image comprises comparing the values of the one or more parameters of each pixel associated with the subsequently captured image with the corresponding values of the one or more parameters of corresponding pixel associated with the captured image. Further, detecting user interaction by comparing a captured image with a subsequently captured image comprises initiating the one or more actions associated with interactive UI element with which one or more users are interacting if it is determined that there is a difference in the compared values.

In an embodiment of the present invention, if it is determined that there is no difference in the compared values then the processing module captures another image of the projected interactive image.

The computer-implemented method for projecting one or more interactive images and processing user interaction with the projected one or more interactive images, via program instructions stored in a memory and executed by a processor, comprising projecting one or more interactive images on a surface of one or more tables. The computer-implemented method further comprising capturing a plurality of projected interactive images. Furthermore, the computer-implemented method comprising detecting user interaction by comparing a captured image with a subsequently captured image. In addition, the computer-implemented method comprising triggering one or more actions associated with the detected user interaction.

In an embodiment of the present invention, the computer-implemented method further comprising maneuvering one or more central projecting devices to the one or more tables, wherein the one or more central projecting devices are configured to project the one or more interactive images on the surface of the one or more tables and accurately positioning the one or more maneuvered central projecting devices over the surface of the one or more tables.

In an embodiment of the present invention, the step of projecting the one or more interactive images on the surface of the one or more tables comprises projecting, on the surface of the one or more tables, a blank image with thin outer boundary, wherein the thin outer boundary has predetermined values of one or more parameters. The step of projecting the one or more interactive images on the surface of the one or more tables further comprises capturing the projected blank image by the camera. Furthermore, the step of projecting the one or more interactive images on the surface of the one or more tables comprises locating center of the captured blank image. In addition, the step of projecting the one or more interactive images on the surface of the one or more tables comprises positioning origin of a first coordinate system at the bottom left corner of the captured image. The step of projecting the one or more interactive images on the surface of the one or more tables further comprises sampling a circle having center as the center of the captured blank image, wherein sampling comprises determining values of one or more parameters of points forming circumference of the circle. The step of projecting the one or more interactive images on the surface of the one or more tables further comprises determining if one or more points on the circumference of the circle coincide with the thin outer boundary, wherein if none of the points coincide with the thin outer boundary then another circle having incremented radius is sampled else coordinates of one or more points on the circumference of the circle that coincide with the thin outer boundary are determined with respect to the first coordinate system and then another circle of incremented radius is sampled. The step of projecting the one or more interactive images on the surface of the one or more tables further comprises sampling the subsequent circle having center as the center of the captured blank image, wherein sampling comprises determining values of one or more parameters of points forming circumference of the subsequent circle. Furthermore, the step of projecting the one or more interactive images on the surface of the one or more tables comprises determining coordinates of one or more points on the circumference of the subsequent circle that coincide with the thin outer boundary. In addition, the step of projecting the one or more interactive images on the surface of the one or more tables comprises determining coordinates of all the points forming the thin outer boundary by sampling plurality of circles with incremented radiuses having center as the center of the captured blank image. Also, the step of projecting the one or more interactive images on the surface of the one or more tables comprises aligning an application coordinate system with the first coordinate system by positioning origin of the application coordinate system at the bottom left corner of projection boundary formed using the determined coordinates. The step of projecting the one or more interactive images on the surface of the one or more tables further comprises projecting one or more interactive User Interface (UI) elements and non-interactive areas within the projection boundary with respect to the aligned application coordinate system.

In an embodiment of the present invention, the step of projecting the one or more interactive images on the surface of the one or more tables comprises projecting, on the surface of the one or more tables, a blank image with thin outer boundary, wherein the thin outer boundary has predetermined values of one or more parameters. The step of projecting the one or more interactive images on the surface of the one or more tables further comprises capturing the projected blank image by the camera. Furthermore, the step of projecting the one or more interactive images on the surface of the one or more tables comprises locating center of the captured blank image. In addition, the step of projecting the one or more interactive images on the surface of the one or more tables comprises positioning origin of a first coordinate system at the bottom left corner of the captured image. The step of projecting the one or more interactive images on the surface of the one or more tables comprises sampling a circle having center as the center of the captured blank image, wherein sampling comprises determining values of one or more parameters of points forming circumference of the circle. The step of projecting the one or more interactive images on the surface of the one or more tables further comprises computing an average value of each of the one or more parameters of the circle. The step of projecting the one or more interactive images on the surface of the one or more tables further comprises sampling another circle having center as the center of the captured blank image, wherein sampling comprises determining values of one or more parameters of points forming circumference of the subsequent circle. The step of projecting the one or more interactive images on the surface of the one or more tables further comprises computing an average value of each of the one or more parameters of the subsequent circle. The step of projecting the one or more interactive images on the surface of the one or more tables further comprises comparing the average value of the one or more parameters of the subsequent circle with the corresponding average value of the one or more parameters of the circle, wherein if there is no difference between the compared values then another circle having incremented radius is sampled else if there is a difference between the compared values then coordinates of one or more points on the subsequent circle's circumference that coincide with the thin outer boundary of the projected blank image are determined. The step of projecting the one or more interactive images on the surface of the one or more tables further comprises determining coordinates of all points forming the thin outer boundary by sampling plurality of circles with incremented radiuses having center as the center of the captured blank image. The step of projecting the one or more interactive images on the surface of the one or more tables further comprises aligning an application coordinate system with the first coordinate system by positioning origin of the application coordinate system at the bottom left corner of projection boundary formed using the determined coordinates. The step of projecting the one or more interactive images on the surface of the one or more tables further comprises projecting one or more interactive User Interface (UI) elements and non-interactive areas within the projection boundary with respect to the aligned application coordinate system.

In an embodiment of the present invention, the one or more points coinciding with the thin outer boundary of the projected blank image are determined by comparing the values of the one or more parameters of each of the one or more points of the subsequent circle's circumference with the average values of the one or more parameters of the circle, wherein the values of the one or more parameters of each of the one or more points of the subsequent circle's circumference that coincide with the thin outer boundary deviate from the average values of the corresponding one or more parameters of the circle which is fully enclosed within the thin outer boundary.

In an embodiment of the present invention, the step of detecting user interaction by comparing the captured image with the subsequently captured image comprises capturing an image of the projected interactive image using the camera. The step of detecting user interaction by comparing the captured image with the subsequently captured image further comprises identifying each of the one or more interactive UI elements within the captured image. Furthermore, the step of detecting user interaction by comparing the captured image with the subsequently captured image comprises segmenting each of the identified one or more interactive UI elements into one or more pixels. In addition, the step of detecting user interaction by comparing the captured image with the subsequently captured image comprises determining values of one or more parameters of the one or more pixels associated with the first captured image. Also, the step of detecting user interaction by comparing the captured image with the subsequently captured image comprises capturing another image of the projected interactive image. The step of detecting user interaction by comparing the captured image with the subsequently captured image comprises identifying each of the one or more interactive UI elements within the subsequently captured image. The step of detecting user interaction by comparing the captured image with the subsequently captured image further comprises segmenting each of the identified one or more interactive UI elements into one or more pixels. Furthermore, the step of detecting user interaction by comparing the captured image with the subsequently captured image comprises determining values of one or more parameters of the one or more pixels associated with the subsequently captured image. The step of detecting user interaction by comparing the captured image with the subsequently captured image comprises comparing the values of the one or more parameters of each pixel associated with the subsequently captured image with the corresponding values of the one or more parameters of corresponding pixel associated with the first captured image. The step of detecting user interaction by comparing the captured image with the subsequently captured image comprises initiating the one or more actions associated with interactive UI element with which one or more users are interacting if it is determined that there is a difference in the compared values. In an embodiment of the present invention, if it is determined that there is no difference in the compared values then the processing module captures another image of the projected interactive image.

A computer program product for projecting one or more interactive images and processing user interaction with the one or more interactive images is provided. The computer program product comprises a non-transitory computer-readable medium having computer-readable program code stored thereon, the computer-readable program code comprising instructions that when executed by a processor, cause the processor to project one or more interactive images on a surface of one or more tables. The processor further captures a plurality of projected interactive images. Furthermore, the processor detects user interaction by comparing a captured image with a subsequently captured image. Also, the processor triggers one or more actions associated with the detected user interaction.

### BRIEF DESCRIPTION OF THE ACCOMPANYING DRAWINGS

The present invention is described by way of embodiments illustrated in the accompanying drawings wherein:

FIG. 1 is a block diagram illustrating a system for projecting one or more interactive images and processing user response and gestures, in accordance with an embodiment of the present invention;

FIG. 2 is a detailed block diagram of a central projecting device and an exemplary projected interactive image, in accordance with an embodiment of the present invention;

FIGS. 3A and 3B represent a flowchart of a method for projecting one or more interactive images on table surfaces and processing user interaction and gestures, in accordance with an embodiment of the present invention;

FIGS. 4A, 4B and 4C represent a detailed flowchart for projecting an interactive image on the surface of the table, in accordance with an embodiment of the present invention;

FIGS. 5A, 5B and 5C represent a detailed flowchart for detecting user interaction with the one or more interactive UI elements of the projected interactive image, in accordance with an embodiment of the present invention;

FIGS. 6A to 6G illustrate steps for projecting the interactive image and detecting user interaction with the projected interactive image, in accordance with an exemplary embodiment of the present invention; and

FIG. 7 illustrates an exemplary computer system for projecting one or more interactive images and processing user response and gestures, in accordance with an embodiment of the present invention.

### DETAILED DESCRIPTION OF THE INVENTION

A system and method for projecting one or more interactive images and processing user response and gestures is described herein. The invention provides for a system and method that eliminates the need of manually placing the orders in a restaurant. The invention further provides for a system and method that provides a virtual menu on the table of a customer that is interactive, cost effective, and easy to maintain.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

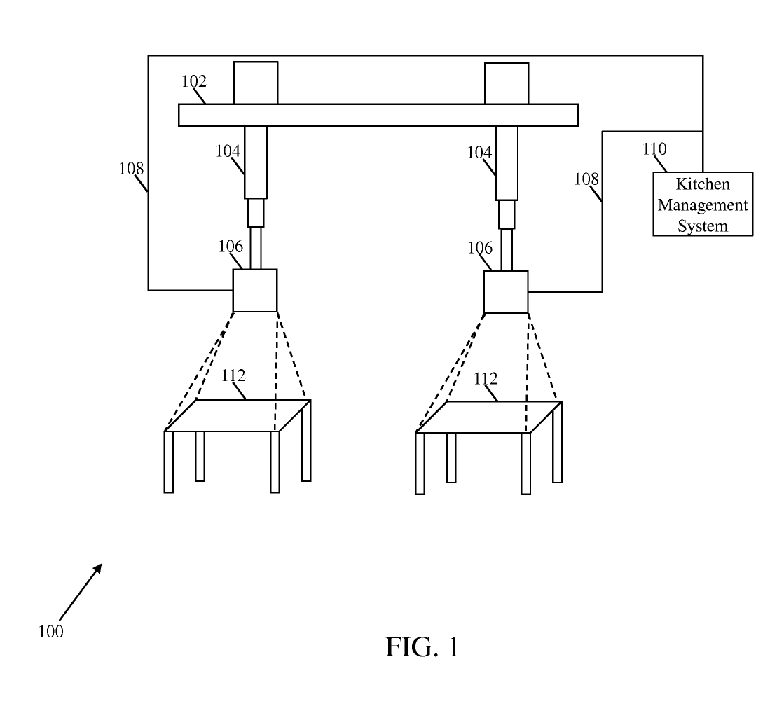

FIG. 1 is a block diagram illustrating a system for projecting one or more interactive images and processing user interaction and gestures, in accordance with an embodiment of the present invention. The system 100 comprises an overhead delivery unit 102, one or more inverted telescopic tube assemblies 104, one or more central projecting devices 106, a data integration link and 108 and a kitchen management system 110.

The overhead delivery unit 102 is assembled to maneuver one or more central projecting devices 106 to one or more tables 112 in a restaurant. Further, the overhead delivery unit 102 manages each of the one or more central projecting devices 106. In an embodiment of the present invention, each of the one or more tables 112 are equipped with a menu button (not shown) configured to invoke the one or more central projecting devices 106 via the overhead delivery unit 102. In an embodiment of the present invention, invocation can be through a wired or wireless link. In an embodiment of the present invention, the overhead delivery unit 102 assigns an available central projecting device 102 to the table invoking the device. The overhead delivery unit 102 further monitors the usage of the central projecting device 106 and once the table has been served and the central projecting device 106 is in idle mode, it is made available for re-use by guests sitting on other tables. In an embodiment of the present invention, the idle mode refers to a state of the central projecting device 106 wherein no user interaction is detected by the central projecting device 106 for a predetermined interval of time.

In an embodiment of the present invention, the overhead delivery unit 102 is a light ceiling-mounted rail. Further, the overhead delivery unit 102 runs as a network of railing in a crisscross arrangement to cover the entire restaurant area and accurately maneuver the one or more central projecting devices 106 over the one or more tables 112.

The one or more inverted telescopic tube assemblies 104 are configured to accurately position the one or more central projecting devices 106 over upper surface of the one or more tables 112. Further, accurate positioning of the one or more central projecting devices 106 over the upper surface of the one or more tables facilitate in accurately projecting one or more interactive images. Furthermore, each of the one or more inverted telescopic tube assemblies 104 comprises an inverted telescopic tube and a servo motor. The inverted telescopic tube facilitates in lowering the one or more central projecting devices 106 to an appropriate distance from the table. The servo motor, attached to the inverted telescopic tube, facilitates precise positioning of the one or more central projecting devices 106 for projecting a clear and sharp interactive image.

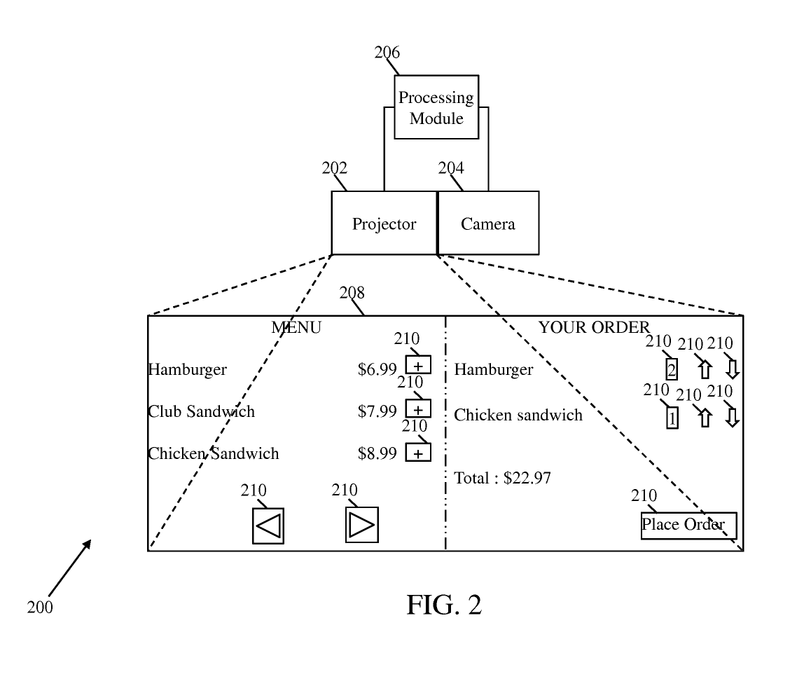

The one or more central projecting devices 106 are configured to facilitate projecting the one or more interactive images on the upper surface of the one or more tables 112. In various embodiments of the present invention, the one or more interactive images may be projected on any other surface of the one or more tables. The one or more central projecting devices 106 are explained in detail in conjunction with FIG. 2.

FIG. 2 is a detailed block diagram of a central projecting device and an exemplary projected interactive image, in accordance with an embodiment of the present invention. The central projecting device 200 comprises a projector 202, a camera 204 and a processing module 206.

The projector 202 is configured to project a blank image on the upper surface of the one or more tables 112 (FIG. 1). The blank image has a thin outer boundary having predetermined values of the one or more parameters. In an embodiment of the present invention, the one or more parameters include, but not limited to, color, intensity and brightness. In an embodiment of the present invention, the blank image is a rectangle having a thin outer boundary of predetermined color and high intensity or brightness. In various embodiments of the present invention, the blank image may be of any shape such as, but not limited to, rectangle, square, triangle, ellipse, star-shape and circle. In an embodiment of the present invention, the blank image is projected for a very short duration and is not captured by the human eye. In an exemplary embodiment of the present invention, the blank image is projected for 1/20 of a second.

The camera 204 is configured to capture the blank image projected by the projector 202 on the upper surface of the table. The captured image is then sent to the processing module 206.

The processing module 206 is configured to process the captured image and position a first coordinate system at the bottom left corner of the captured image. The processing module 206 then determines coordinates of the boundary of the projected blank image with respect to the first coordinate system. In an embodiment of the present invention, the processing module 206 comprises a software application for processing the captured image and determining the coordinates of the boundary of the projected blank image.

Once the coordinates of the boundary of the projected blank image are determined, the processing module 206 facilitates the projector 202 to render a rectangle using the determined coordinates. In an embodiment of the present invention, the coordinates of the points on the boundary of the projected blank image may not form a perfect rectangle due to distortion of the projected blank image. In an embodiment of the present invention, the distortion is due to keystone effect. The processing module 206 is configured to examine the corner points of the boundary and detect any distortion. The processing module 206 is further configured to measure and implement the angular correction required to project the interactive image as a rectangle.

The rendered rectangle is the projection boundary of the interactive image to be projected on the upper surface of the table. The processing module 206 then aligns an application coordinate system with the first coordinate system by positioning origin of the application coordinate system into lower left corner of the rendered rectangle. The processing module 206 further facilitates the projector 202 to project one or more interactive User Interface (UI) elements 210 and non-interactive areas with respect to the application coordinate system within the rendered rectangle. In various embodiments of the present invention, the interactive image may be of any shape such as, but not limited to, triangular, square, elliptical and circular.

The one or more interactive User Interface (UI) elements 210 and the non-interactive areas form the projected interactive image 208. The one or more interactive UI elements 210 are areas that provide one or more options to the one or more users for interacting with the projected interactive image 208 using one or more hand gestures. The non-interactive areas are static regions within the projected interactive image that do not trigger any action.

In an embodiment of the present invention, the one or more interactive UI elements 210 provide one or more options to the one or more users to select or de-select a food or beverage item. In another embodiment of the present invention, the one or more interactive UI elements 210 provide an option to flip pages of the menu. In yet another embodiment of the present invention, the one or more interactive UI elements 210 provide an option to rotate the menu. In yet another embodiment of the present invention, the one or more interactive UI elements 210 facilitate the one or more users to provide instructions by a virtual keyboard. Further, the placement of the one or more interactive UI elements 210 with respect to the application coordinate system is pre-stored in the processing module 206. Furthermore, shape of each of the one or more interactive UI elements 210 is also pre-stored in the processing module 206. In an embodiment of the present invention, the shape and placement of each of the one or more interactive UI elements 210 is stored in the form of one or more equations and solution boundaries with respect to the application coordinate system.

The camera 204 and the processing module 206 continuously monitor the projected interactive image 208 to detect user interaction. The camera 204 and the processing module 206 captures a series of images and further processes the captured images to recognize user interaction. In an embodiment of the present invention, the processing module 206 uses a background subtraction technique to identify the one or more interactive UI elements 210 with which the user is interacting.

In operation, the processing module 206 facilitates the camera 204 to capture a first image of the projected interactive image 208. The processing module 206 identifies each of the one or more interactive UI elements 210 in the captured first image using the pre-stored equations and solution boundaries. The processing module 206 then divides each of the one or more identified interactive UI elements of the captured first image into one or more contiguous squares and determines values of each of the one or more parameters associated with the one or more squares. In an embodiment of the present invention, the one or more contiguous squares are pixels of the captured first image. Further, the processing module 206 calculates average value of each of the one or more parameters associated with the first captured image.

The processing module 206 then facilitates the camera 204 to capture a second image of the projected interactive image 208. The processing module 206 calculates average value of each of the one or more parameters associated with the second captured image. The processing module 206 then compares the average values for each of the one or more parameters associated with the first captured image and the second captured image using a paired sample t-test. If the one or more users do not interact with the one or more interactive UI elements 210, no significant difference is detected in the two average values and the processing module 206 continues processing the next image captured by the camera 204.

If the one or more users interact with the projected image and perform the one or more hand gestures associated with an interactive UI element 210 then on comparing the average value of each of the one or more parameters of the first captured image with the average value of each of the one or more parameters of the second captured image, significant difference is detected by the processing module 206. The processing module 206 then determines the interactive UI element 210 facilitating deviation in the average value of the one or more parameters of the second captured image and facilitates in performing the action associated with the interactive UI element 210.

In an embodiment of the present invention, the action associated with the interactive UI element 210 and performed by the processing module 206 includes facilitating the projector 202 to project a new interactive image. In another embodiment of the present invention, the processing module 206 facilitates sending a trigger to the kitchen management system 110 (FIG. 1) via a data integration link 108 (FIG. 1) to place an order. In yet another embodiment of the present invention, the processing module 206 facilitates communication with an external system such as, but not limited to, a payment gateway to process the payment. In yet another embodiment of the present invention, the processing module 206 facilitates communication with one or more external systems such as, but not limited to, World Wide Web, Short Messaging Service (SMS) server and electronic mail server for sending messages and invites.

In an exemplary restaurant setting, the interactive image 208 projected on the upper surface of the table 112 (FIG. 1) is a menu of the restaurant. The one or more users such as, but not limited to, patrons at the restaurant use the hand gestures associated with the one or more options to perform various activities such as, but not limited to, viewing the menu, placing order, facilitating payment, playing games, viewing albums and sending invites. Once the order is placed via the projected interactive image 208 (FIG. 2), the order is delivered to the kitchen management system 110 (FIG. 1) via the data integration link 108 (FIG. 1).

Referring back to FIG. 1, if the one or more users place an order by using the one or more interactive UI elements 210 (FIG. 2) of the projected image 208 (FIG. 2), then the processing module 206 (FIG. 2) communicates with the kitchen management system 110 via the data integration link 108 for delivering the placed order. In an embodiment of the present invention, the data integration link 108 is a Local Area Network (LAN).

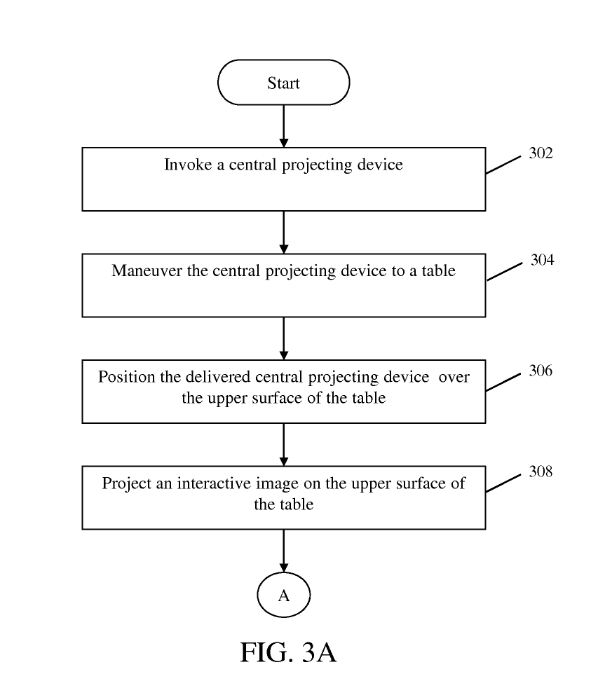

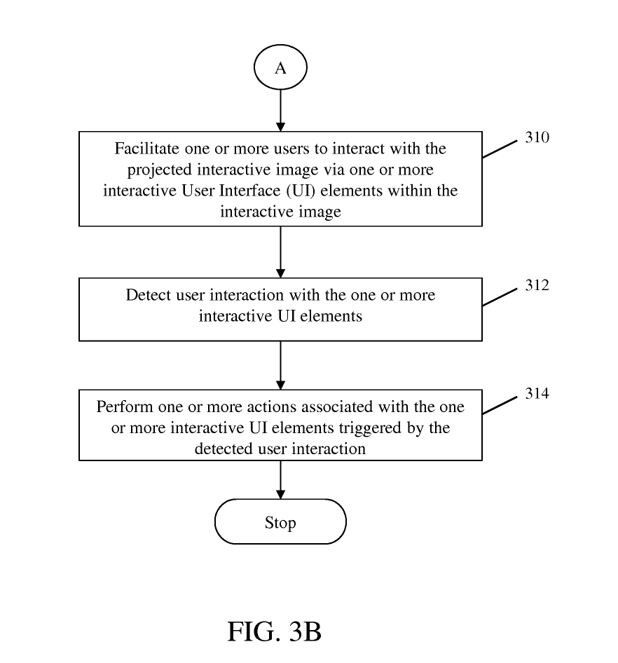

FIGS. 3A and 3B represent a flowchart of a method for projecting one or more interactive images on table surfaces and processing user interaction and gestures, in accordance with an embodiment of the present invention.

At step 302, a central projecting device is invoked from a table. In an embodiment of the present invention, each table in a restaurant is equipped with a menu button. One or more users such as, but not limited to, patrons in the restaurant press the menu button on the table to invoke and facilitate maneuvering the central projecting device to their table. In an embodiment of the present invention, invocation of the central projecting device can be through a wired or wireless link.

At step 304, the central projecting device is maneuvered to the table. The central projecting device is maneuvered via an overhead delivery unit. Further, the overhead delivery unit is a light ceiling-mounted rail in a crisscross arrangement which covers the entire restaurant area to accurately maneuver one or more projecting devices over one or more tables. The overhead delivery unit further manages the one or more central projecting devices. The overhead delivery unit assigns an available central projecting device to the table invoking the device. The overhead delivery unit further monitors the usage of the one or more central projecting devices and once the table has been served and the central projecting device is in idle mode, it is made available for re-use by guests sitting on other tables. In an embodiment of the present invention, the idle mode refers to a state of the central projecting device wherein no user interaction is detected for a predetermined interval of time.

At step 306, the maneuvered central projecting device is accurately positioned over the upper surface of the table. Further, accurate positioning of the central projecting device over the upper surface of the table facilitates in accurately projecting one or more interactive images. In an embodiment of the present invention, an inverted telescopic tube facilitates lowering the central projecting device to an appropriate level to facilitate projecting a clear and sharp interactive image. In an embodiment of the present invention, the inverted telescopic tube is attached with a servo motor which facilitates precise positioning of the central projecting device.

At step 308, an interactive image is projected on the upper surface of the table by a projector.

In an embodiment of the present invention, the step of projecting an interactive image on the table comprises various sub-steps. The projector first projects a blank image on the upper surface of the table. The blank image has a thin outer boundary having predetermined values of the one or more parameters. In an embodiment of the present invention, the one or more parameters include, but not limited, color, intensity and brightness. In an embodiment of the present invention, the blank image has a thin outer boundary of predetermined color and high intensity or brightness. A camera then captures and sends the blank image projected by the projector to a processing module.

The processing module processes the captured image and positions a first coordinate system at the bottom left corner of the captured image. The processing module then determines coordinates of the boundary of the projected blank image with respect to the first coordinate system.

Once the coordinates of the boundary of the projected blank image are determined, the processing module facilitates rendering a rectangle using the determined coordinates. The processing module further facilitates the projector to project the interactive image within the boundary of the rectangle. The step of projecting the interactive image on the upper surface of the table by a projector is explained in detail in later sections of the specification.

At step 310, the one or more users interact with the projected interactive image via one or more interactive User Interface (UI) elements within the projected interactive image. Further, the projected interactive image comprises one or more interactive UI elements and non-interactive areas. The one or more interactive UI elements are areas that provide one or more options to the one or more users for interacting with the projected interactive image using one or more hand gestures. The non-interactive areas are static regions within the projected interactive image that do not trigger any action. In an embodiment of the present invention, the one or more interactive UI elements provide one or more options to the one or more users to select or de-select a food or a beverage item. In another embodiment of the present invention, the one or more interactive UI elements provide an option to flip pages of the menu. In yet another embodiment of the present invention, the one or more interactive UI elements provide an option to rotate the menu. In yet another embodiment of the present invention, the one or more interactive UI elements facilitate the one or more users to provide instructions by a virtual keyboard. Further, the placement of the interactive UI elements with respect to the application coordinate system is pre-stored in the processing module. Furthermore, shape of each of the one or more interactive UI elements is also pre-stored in the processing module. In an embodiment of the present invention, the shape of each of the one or more interactive UI elements is stored in the form of one or more equations. The one or more equations may also have one or more solution boundaries.

At step 312, user interaction with the one or more interactive UI elements is detected. The camera and the processing module continuously monitor the projected interactive image to detect user interaction. The camera and the processing module capture a series of images and further processes the captured images to recognize user interaction.

In operation, the camera captures and sends a first image of the projected interactive image to a processing module. The processing module identifies each of the one or more interactive UI elements in the captured first image using the pre-stored equations and solution boundaries. The processing module then divides each of the one or more interactive UI elements of the captured first image into one or more contiguous squares and determines values of each of the one or more parameters associated with the one or more squares. The processing module then calculates average value of each of the one or more parameters associated with the first captured image.

The processing module then facilitates the camera to capture a second image of the projected interactive image. The processing module then divides each of the one or more interactive UI elements of the captured second image into one or more contiguous squares and determines values of each of the one or more parameters associated with the one or more squares. The processing module then calculates average value of each of the one or more parameters associated with the second captured image. The processing module 206 then compares the average values for each of the one or more parameters associated with the first captured image and the second captured image using a paired sample t-test. If the one or more users do not interact with the one or more interactive UI elements, no significant difference is detected in the two average values and the processing module continues processing the next image captured by the camera.

If the one or more users interact with the projected image and perform the one or more hand gestures associated with an interactive UI element then on comparing the average values of each of the one or more parameters of the first captured image and second captured image, significant difference is detected by the processing module. The processing module then determines the interactive UI element facilitating deviation in the average value of the one or more parameters of the second captured image and facilitates in performing an action associated with the interactive UI element. The step of detecting user interaction with the one or more interactive UI elements is explained in detail in later sections of the specification.

At step 314, one or more actions associated with the one or more interactive UI elements, with which the one or more users are interacting, are performed by the processing module. In an embodiment of the present invention, the action performed by the processing module includes facilitating the projector to project a new interactive image. In another embodiment of the present invention, the processing module facilitates sending a trigger to a kitchen management system for placing an order. In yet another embodiment of the present invention, the processing module facilitates communication with an external system such as, but not limited to, a payment gateway to process the payment. In yet another embodiment of the present invention, the processing module facilitates communication with one or more external systems such as, but not limited to, World Wide Web, Short Messaging Service (SMS) server and electronic mail server for sending messages and invites to other users.

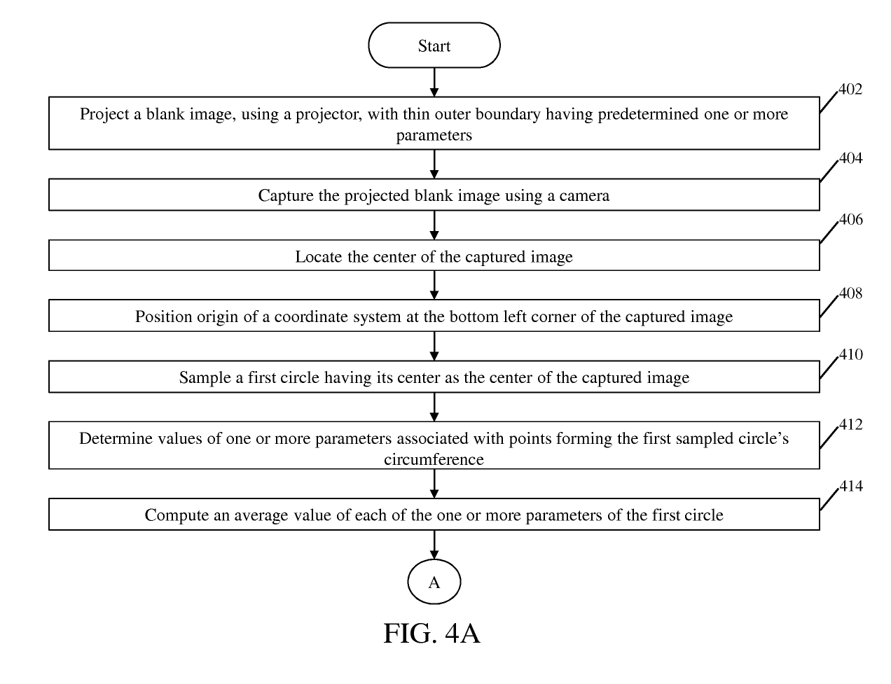

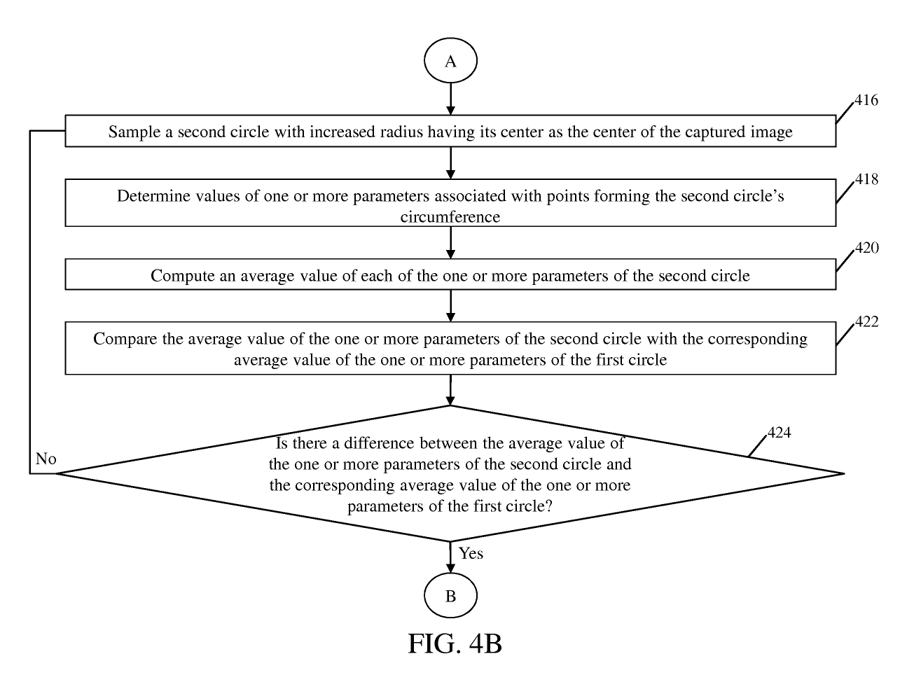

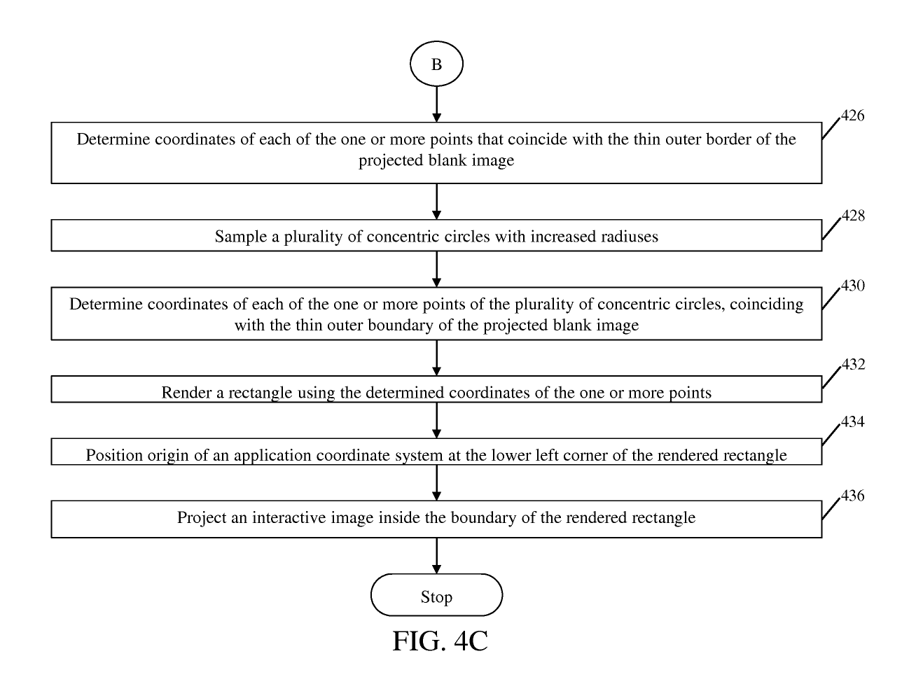

FIGS. 4A, 4B and 4C represent a detailed flowchart for projecting an interactive image on the surface of the table, in accordance with an embodiment of the present invention.

At step 402, a blank image with thin outer boundary having predetermined values of one or more parameters is projected on the upper surface of the table by the projector. In an embodiment of the present invention, the boundary of the image has high intensity or brightness. In an embodiment of the present invention, the blank image is a boundary marker image used for determining the edges of the projected area. In an embodiment of the present invention, the blank image is projected for a very short duration and is not captured by the human eye. In an exemplary embodiment of the present invention, the blank image is projected for 1/20th of a second.

At step 404, the projected blank image is captured using a camera and sent to a processing module. In an embodiment of the present invention, a photograph of the boundary marker image is captured by the camera.

At step 406, the processing module locates center of the captured image. Once the center of the captured image is located, it facilitates in determining the edges of the projected blank image. In an embodiment of the present invention, the camera is positioned such that the projected blank image is completely photographed by the camera and the edges of the projected blank image are closer to the edges of the photograph. The term “captured image” has been interchangeably used with the term “photograph” in the specification.

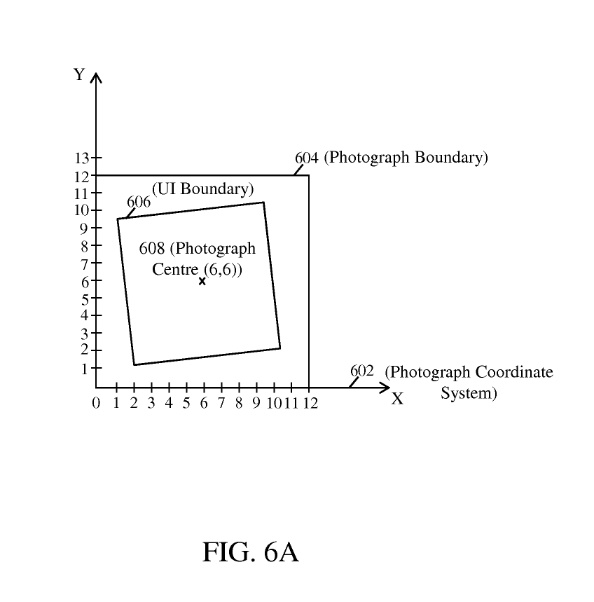

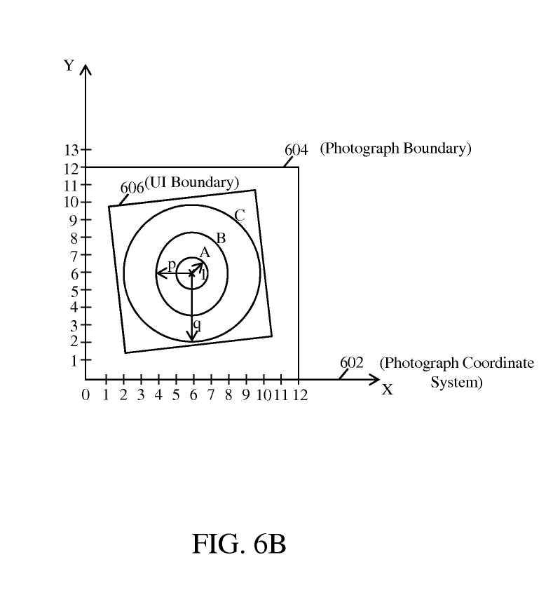

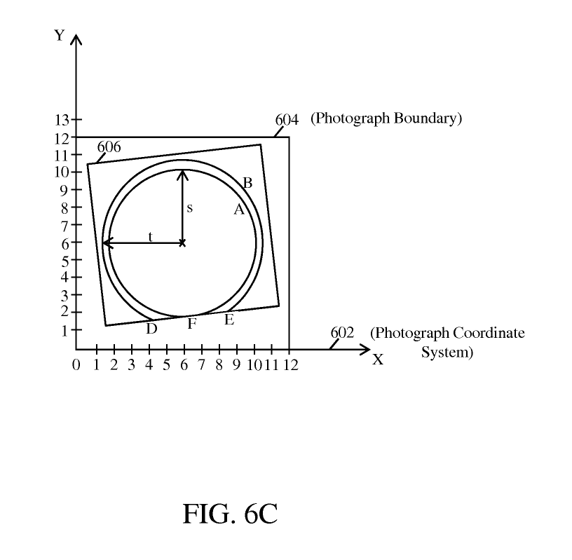

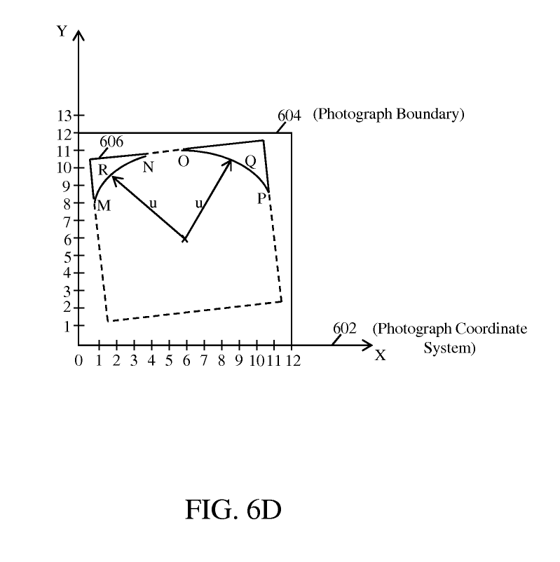

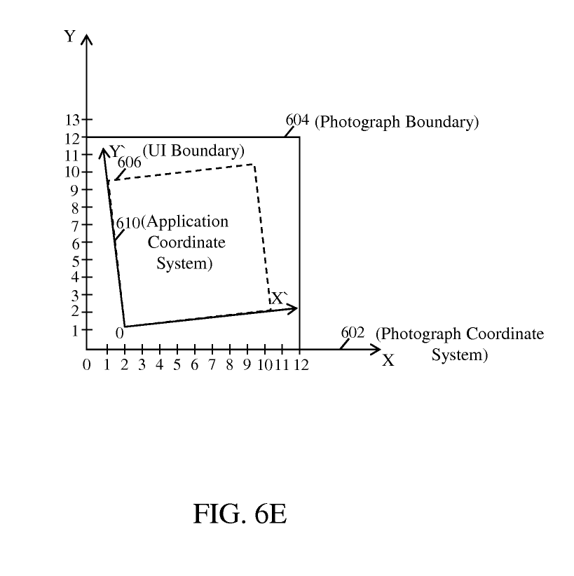

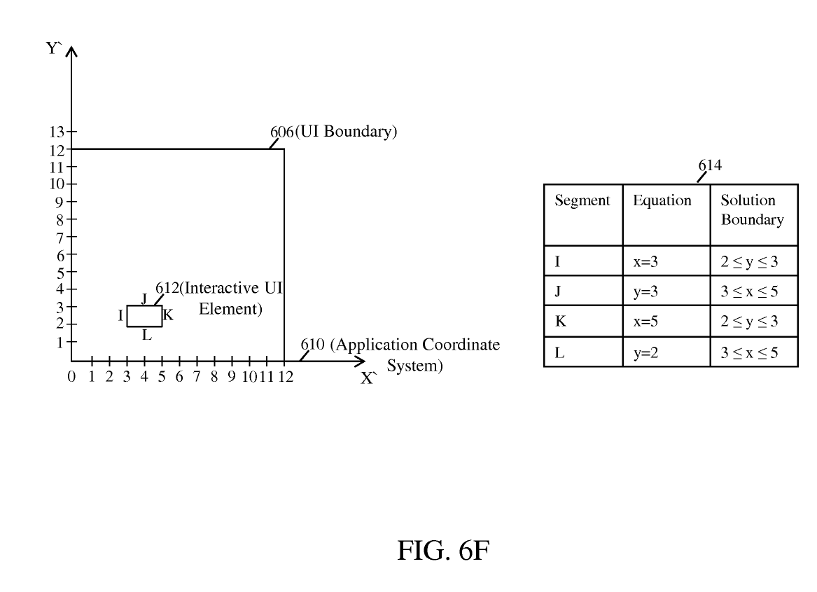

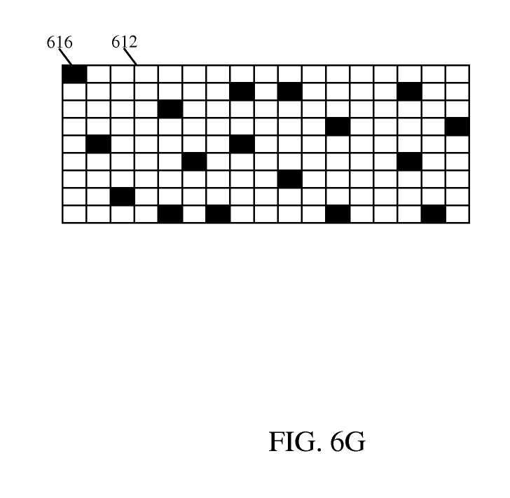

At step 408, the processing module positions origin of a first coordinate system at the bottom left corner of the captured image. In an exemplary embodiment of the present invention, the first coordinate system comprises X-axis and Y-axis with origin at the bottom left corner of the captured image. The processing module determines the center of the photograph with respect to the first coordinate system. The positioning of the first coordinate system is discussed in detail in conjunction with FIG. 6A in later sections of the specification.

At step 410, a first circle of a predetermined radius is sampled. In an embodiment of the present invention, the center of the first circle is at the center of the captured image. In an exemplary embodiment of the present invention, the radius of the projected first circle is 1 pixel.

At step 412, values of one or more parameters associated with points on the first circle's circumference are determined and stored. At step 414, an average value of each of the one or more parameters for the first circle is computed and stored.

At step 416, a second circle with increased radius is sampled. In an embodiment of the present invention, the center of the second circle is at the center of the captured image. At step 418, values of one or more parameters associated with points on the second circle's circumference are determined and stored. At step 420, an average value of each of the one or more parameters for the second circle is computed and stored.

At step 422, the average value of each of the one or more parameters of the second circle are compared with the corresponding average value of each of the one or more parameters of the first circle.

At step 424, a check is performed to ascertain if there is a difference between the compared average value of the one or more parameters of the second circle and the corresponding average value of the one or more parameters of the first circle. If it is ascertained that there is no difference between the two average values, then the control returns to step 416.

If it is ascertained that there is a difference between the average value of the one or more parameters of the second circle and the corresponding average value of the one or more parameters of the first circle, then at step 426, coordinates of each of the one or more points that coincide with the thin outer boundary of the projected blank image are determined and stored.

The one or more points coinciding with the thin outer boundary are determined by comparing the values of each of the one or more parameters of the one or more points on the second circle's circumference with the average value of the corresponding one or more parameters of the first circle. As the first circle did not coincide with the thin outer boundary of the projected blank image, there is a deviation in values of the one or more parameters of the one or more points of the second circle's circumference that coincide with the thin outer boundary compared to the average values of the one or more parameters of the first circle.

In an exemplary embodiment of the present invention, the color and intensity value of the point, on the second circle's circumference and coinciding with the thin outer boundary of the projected blank image is determined to be same as the color and intensity value of the thin outer boundary of the projected blank image and is higher than the average value of color and intensity for the points on the first circle's circumference. The coordinates of the points coinciding with the thin outer boundary of the projected blank image are determined with respect to the origin of the first coordinate system positioned at step 408.

At step 428, plurality of concentric circles with center as the center of the captured image are sampled. In an embodiment of the present invention, the radius of the plurality of concentric circles is more than the radius of the first circle and the second circle. In an embodiment of the present invention, one or more circles of increasing radius are sampled until all the points on the thin outer boundary of the projected blank image are determined.

In operation, the processing module continuously removes the segment of the circle which is beyond the points coinciding with the thin outer boundary of the projected blank image. Further, one or more circles of the plurality of concentric circles touches at least one other edge of the thin outer boundary of the projected blank image. Eventually, all segments of the circles beyond the thin outer boundary of the projected blank image disappear. In an embodiment of the present invention, various segments of the plurality of concentric circles are processed on different work threads by the processing module thereby facilitating efficient projection and processing.

At step 430, coordinates of each of the one or more points of the one or more concentric circles coinciding with the thin outer boundary of the projected blank image are determined. Further, the determined coordinates represent the boundary of the interactive image projected by the projector on the surface of the table. In an exemplary embodiment of the present invention, the first coordinate system comprises of X axis and Y axis. Further, the coordinates of the points forming the corners of the thin outer boundary are determined to be min X min Y, min X max Y, max X min Y and max X max Y.

At step 432, a rectangle using the determined coordinates of each of the one or more points is rendered on the upper surface of the table. The rectangle is the projection boundary formed using the determined coordinates.

At step 434, the origin of an application coordinate system is positioned at the lower left corner of the rendered rectangle thereby aligning the application coordinate system with the first coordinate system. In an embodiment of the present invention, the processing module calculates a transformation coefficient based on the difference in scale of the first coordinate system and the application coordinate system. The calculated transformation coefficient is subsequently used to analyze and detect user interaction with the projected interactive image.

At step 436, the interactive image is projected inside the rendered rectangle. Further, the rectangle forms the boundary of the projected interactive image. The one or more interactive UI elements and non-interactive areas are projected within the rendered rectangle using the pre-stored equations and solution boundaries of the one or more interactive UI elements with respect to the application coordinate system.

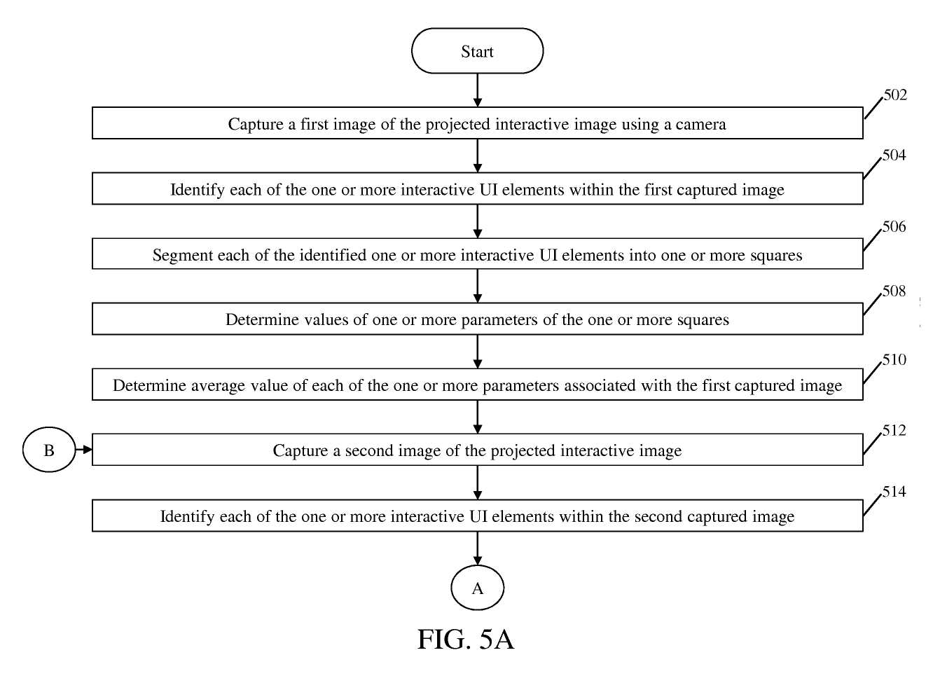

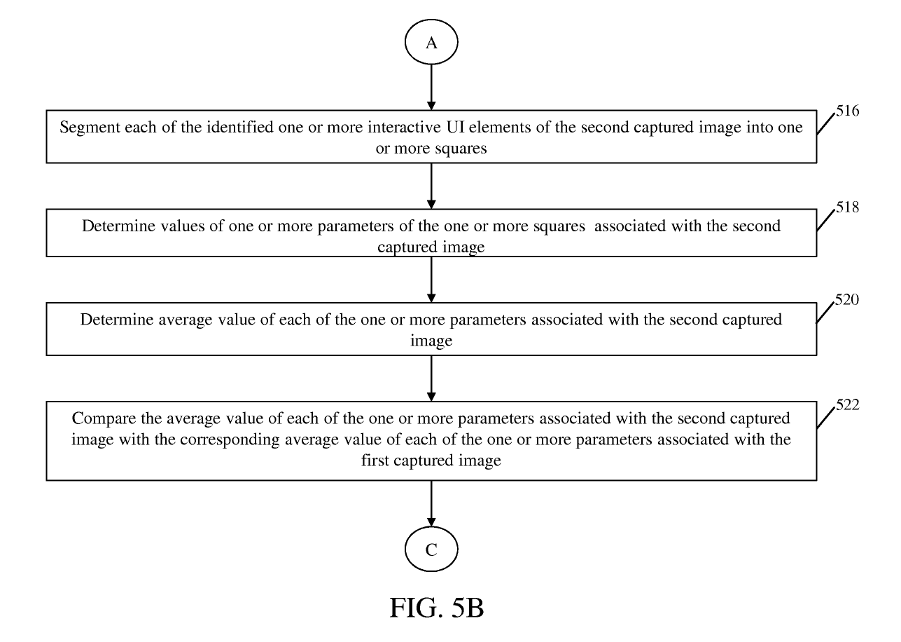

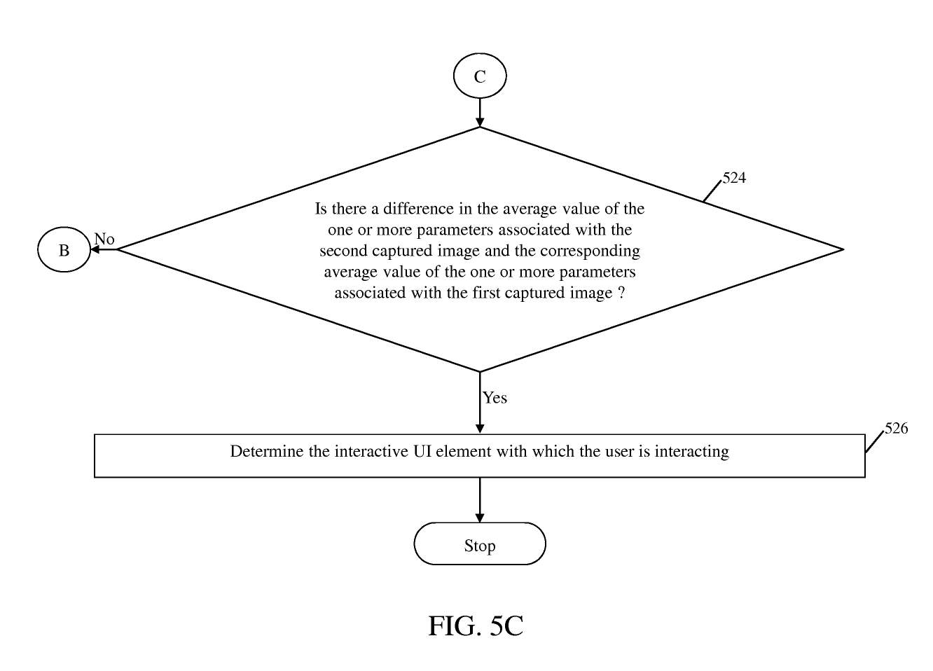

FIGS. 5A, 5B and 5C represent a detailed flowchart for detecting user interaction with the one or more interactive UI elements of the projected interactive image, in accordance with an embodiment of the present invention.

At step 502, a first image of the projected interactive image is captured using a camera. At step 504, each of the one or more interactive UI elements within the first captured image are identified using the pre-stored equations and solution boundaries of the one or more interactive UI elements.

At step 506, each of the identified one or more interactive UI elements are segmented into one or more squares. In an embodiment of the present invention, the one or more squares are pixels of the first captured image. At step 508, values of one or more parameters of the one or more squares are determined.

At step 510, average value of each of the one or more parameters associated with the first captured image is determined.

At step 512, a second image of the projected interactive image is captured. At step 514, each of the one or more interactive UI elements within the second captured image are identified using the pre-stored equations and solution boundaries of the one or more interactive UI elements.

At step 516, each of the identified one or more interactive UI elements of the second captured image are segmented into one or more squares. In an embodiment of the present invention, the one or more squares are pixels forming the second captured image. At step 518, values of one or more parameters of the one or more squares associated with the second captured image are determined.

At step 520, average value of each of the one or more parameters associated with the second captured image is determined.

At step 522, the average value of each of the one or more parameters associated with the second captured image is compared with the corresponding average value of each of the one or more parameters associated with the first captured image using a t-test.

At step 524, a check is performed to ascertain whether there is a difference in the average value of the one or more parameters associated with the second captured image and the average value of the corresponding one or more parameters associated with the first captured image. If it is ascertained that there is no difference in the two average values, then the control returns to step 512.

If it is ascertained that there is a difference in the average value of the one or more parameters associated with the second captured image and the corresponding average value of the one or more parameters associated with the first captured image, then at step 526, the interactive UI element with which the user is interacting is determined.

In an embodiment of the present invention, the interactive UI element with which the user is interacting is determined by comparing the values of the one or more parameters of the one or more interactive UI elements associated with the second captured image with the corresponding values of the one or more parameters of the one or more interactive elements associated with the first captured image.

In an exemplary embodiment of the present invention, the color and intensity or brightness value of the interactive UI element will change if the one or more users perform a gesture associated with the interactive UI element. The gesture would be captured by the camera in the second captured image. However, the gesture would not be present in the first captured image. As a result, the color and intensity value of the interactive UI element of the second captured image would differ significantly from the color and intensity value of the interactive UI element of the first captured image thus detecting user interaction.

In an exemplary embodiment of the present invention, the processing module also facilitates in determining whether the difference in the color and intensity value of the interactive UI element is due to continuous user interaction with the projected interactive image or due to a stationary object being placed on the interactive UI element. In operation, the processing module captures plurality of images of the projected interactive image and computes average values of the one or more parameters for each of the plurality of images. The processing module then compares the computed average values of the one or more parameters for the plurality of images. If the one or more users are interacting with the projected interactive image then the average values of the one or more parameters would be different for each of the plurality of images. However, if the one or more users are not interacting with the interactive UI element and have only placed an object on the interactive UI element of the projected interactive image, then the average values of the one or more parameters are different in initially captured images, however the average values of the one or more parameters of the interactive UI element are same in subsequently captured images. The user's intent of interacting with the one or more interactive UI elements is thereby determined by the processing module.

Once the user interaction with the interactive UI element is detected, the processing module facilitates changing color of the interactive UI element projected on the upper surface of the table. Further, if the user continues the interaction with the interactive UI element, then the processing module triggers appropriate action such as, projecting a new interactive image, facilitating appropriate UI transition, sending a trigger to a kitchen management system for placing an order and communicating with one or more external systems. The one or more external systems include, but not limited to, World Wide Web, Short Messaging Service (SMS) server, electronic mail server and payment gateway.

FIGS. 6A-6G illustrate steps for projecting the interactive image and detecting user interaction with the projected interactive image, in accordance with an exemplary embodiment of the present invention.

To begin with, the central projecting device is invoked by the patrons in the restaurant by pressing a button on the table. The central projecting device is maneuvered to the table and is accurately positioned over the upper surface of the table. Once the central projecting device is positioned, a blank image having border of pre-determined brightness and color is projected. In an embodiment of the present invention, the blank image is black in color with a bright green border. The black image is projected for a very short duration so as to be invisible to the patrons at the restaurant. The camera attached to the central projecting device takes a photograph of the projected black image with bright green border. The processing module within the central projecting device then determines the center of the photograph and positions a first coordinate system with origin at bottom left corner of the photograph.

Referring now to FIG. 6A which represents the photograph of the projected blank image along with the positioned first coordinate system. The first coordinate system, comprising X-axis and Y-axis, is illustrated as photograph coordinate system 602. The boundary of the photograph is illustrated as photograph boundary 604. The boundary of the black image having bright border is shown as User Interface (UI) boundary 606. The center of the photograph is illustrated as photograph center 608. The coordinates of the photograph center 608 are positioned at x=6 and y=6, wherein x represents X-axis and y represents Y-axis of the photograph coordinate system 602.

For determining the coordinates of the points on the UI boundary 606, the processing module starts sampling circles one after the other, of pre-determined radiuses, having center as the photograph center 608. Usually, each time a new circle is sampled, its radius is incremented by 1 pixel in comparison with the previously sampled circle.

Now referring to FIG. 6B which represents three concentric circles within the UI boundary 606 sampled by the processing module.

Typically, the first sampled circle A has a radius of 1 pixel. The equation of the first circle A can be represented as (x−6)²+(y−6)²=1²ₚₓ. The processing module determines and stores the color and brightness values of all the points on the circumference of the first sampled circle A. On comparing the color and brightness values of all the points of the circle A with the color and brightness values of the UI boundary 606, the processing module determines that the first sampled circle A falls within the UI boundary.

The processing module then samples another circle B of p pixels. The equation of the second circle B can be represented as (x−6)²+(y−6)²=p²ₚₓ. The color and brightness values of all the points on the circumference of the sampled circle B are determined and stored. On comparing the color and brightness values of all the points of the projected circle B with the color and brightness values of the UI boundary 606, the processing module determines that the sampled circle B also falls within the UI boundary 606.

The processing module then samples a third circle C of q pixels. The equation of the third circle C can be represented as (x−6)²+(y−6)²=q²ₚₓ. As determined for circle A and circle B above, the processing module determines that circle C also falls within the UI boundary 606.

The processing module continuously sample circles of incremented pre-determined radiuses having center as the photograph center 608. Eventually, a sampling circle touches the brightly colored UI boundary 606 as illustrated in FIG. 6C.

Referring now to FIG. 6C which represents two concentric circles coinciding with the UI boundary 606. The processing module first samples circle A of s pixels which is mathematically represented as (x−6)²+(y−6)²=s²ₚₓ. The processing module then determines the color and brightness values of all the points on the circumference of the circle A. Thereafter, the processing module compares the determined color and brightness values of all the points on the circumference of the sampled circle A with the brightness and color values of the UI boundary 606. On comparison, the processing module determines that color and brightness values for a point F lying on the circumference of the sampled circle A are equivalent to the color and brightness values of the UI boundary 606. The processing module thereby concludes that the point F coincide with the brightly coloured UI boundary 606 and stores the coordinates of the point F with respect to the photograph coordinate system 602.

The processing module then samples another circle B of t pixels. The equation of the second circle B can be represented as (x−6)²+(y−6)²=t²ₚₓ. In the same way as done for circle A above, the processing module also determines the color and brightness values of all the points on the circumference of the sampled circle B. Thereafter, the processing module compares the determined color and brightness values of all the points on the circumference of the sampled circle B with the brightness and color values of the UI boundary 606. On comparison, the processing module determines that color and brightness values for a point D and a point E lying on the circumference of the sampled circle B are equivalent to the color and brightness values of the UI boundary 606. The processing module thereby concludes that the point D and the point E coincide with the brightly coloured UI boundary 606 and stores the coordinates of both the points.

In an alternate embodiment of the present invention, the processing module does not examine points on the circumference lying beyond the segment D-E as it contains already identified UI boundary points. The processing module therefore limits the solution for the circle's circumference between the most distant points coinciding with the UI boundary 606 ranging from point D to point E.

Referring now to FIG. 6D which represents a state where coordinates of a number of points on the UI boundary 606 have been determined.

The processing module samples another circle of u pixels. The circle is mathematically represented as (x−6)²+(y−6)²=u²ₚₓ. In an embodiment of the present invention, as done for circle A (FIG. 6C) and circle B (FIG. 6C) above, the processing module determines the coordinates of all the points coinciding with the UI boundary 606 by comparing the color and brightness values of all the points of the sampled circle of u pixels with the color and brightness values of the UI boundary 606.

The processing module keeps on sampling more circles of increased radiuses for determining coordinates of all other points of the UI boundary 606.

In an alternate embodiment of the present invention, if most of the points on the UI boundary 606 have been identified, as depicted in FIG. 6D, then the processing module examines only those segments which have been left. As shown in FIG. 6D, the segments of the circle ranging from points N to O and points M to P are not examined as points on the UI boundary 606 within these segments are already determined and stored while examining sampling circles of lesser radiuses. Therefore, only segments Q (ranging from points O to P) and R (ranging from points M to N) of the circle are examined. The processing module determines the color and brightness values of all the points on the segments Q and R of the circle. The processing module then compares the color and brightness values of the points on the segment Q and segment R with the brightness and color values of the UI boundary 606. On comparing, as the color and brightness values of the points M, N, O and P are determined to be equivalent to the color and brightness values of the UI boundary 606, the processing module concludes that the points M, N, O, and P coincide with the UI boundary 606. The coordinates of the points M, N, O and P are then determined and stored with respect to the photograph coordinate system 602.

Referring now to FIG. 6E which represents a state where coordinates of all the points forming the UI boundary 606 have been determined with respect to the photograph coordinate system 602.

Once the coordinates of all the points forming the UI boundary 606 have been determined, the processing module positions an application coordinate system 610, having its origin at the lower left corner of the UI boundary 606. The application coordinate system 610 comprises X′ axis and Y′ axis and is ready to render interactive UI elements and non interactive areas. In an embodiment of the present invention, the shape and placement of the one or more interactive UI elements and non-interactive areas are pre-stored in the form of equations and solution boundaries with respect to the application coordinate system 610 in the processing module. The processing module accesses the pre-stored equations and solution boundaries for accurately projecting the one or more interactive UI elements and non-interactive areas within the UI boundary 606. Further, accurately projecting the one or more interactive UI elements and non-interactive areas involves using the equations and solution boundaries to interpret the shape and exact location of the one or more interactive UI elements and non-interactive areas with respect to the application coordinate system 610.

Referring now to FIG. 6F which represents projection of an interactive UI element 612 with respect to the application coordinate system 610 using pre-stored equations and solution boundaries.

The shape and placement of the interactive UI element 612 is pre-stored in the form of equations and solution boundaries with respect to the application coordinate system 610 as illustrated in table 614. In an exemplary embodiment of the present invention, the processing module projects the interactive UI element 612 using the equations and solution boundaries which include four straight line segments I, J, K and L that form a rectangle. The rectangle thus formed is the interactive UI element 612 through which the patrons at the restaurant would interact. In a similar fashion, the other interactive UI elements and non-interactive areas of are projected within the UI boundary 606 in accordance with the application coordinate system 610 to complete rendering of the interactive image on the table.

In an embodiment of the present invention, the processing module performs a programmatic conversion whenever it analyses an image captured by the camera against an internal representation of the interactive UI elements due to difference in scale of the photograph coordinate system 602 (FIG. 6E) and application coordinate system 610.

FIG. 6G represents a magnified view of the interactive UI element 612, in accordance with an embodiment of the present invention.

For detecting user interaction, the processing module facilitates the camera to capture a first image of the projected interactive image. The interactive UI element 612 within the captured first image is then divided into numerous pixels by the processing module. The processing module selects and analyzes a set of random pixels depicted as shaded pixels 616. The processing module then determines the color value and brightness value for each of the shaded pixels 616 of the first captured image. Further, the processing module captures a second image and determines the color value and brightness value of the same set of shaded pixels 616 for the second captured image. The processing module then performs a 2-sample t-test to determine if there is any statistically significant difference in the color and brightness values of the same set of shaded pixels 616 for the first captured image and the second captured image. If there is a statistically significant difference between the color and brightness values of the same set of shaded pixels 616 for the first captured image and the second captured image, then the processing module determines that the user is interacting with the interactive UI element 612. In an embodiment of the present invention, the processing module detects such differences for a series of captured images over sufficiently long duration of time to ensure that the user is interacting with the interactive UI element.

During operation, the processing module facilitates the camera to capture a series of images. In an exemplary embodiment of the present invention, the camera captures 20 to 24 images per second for detecting user interaction. Further, the processing module continuously compares a set of two consecutively captured images, in the manner described above, for detecting user interaction with the one or more interactive UI elements. The processing module then facilitates performing the one or more actions associated with the interactive UI element with which the user is interacting. The one or more actions may involve user interface transitions based on user interaction, rendering a menu, selecting an order from the menu, placing an order and facilitating payment.

The present invention may be used in various settings and establishments including, but not limited to, restaurants, shops, hotels, offices and self service kiosks.

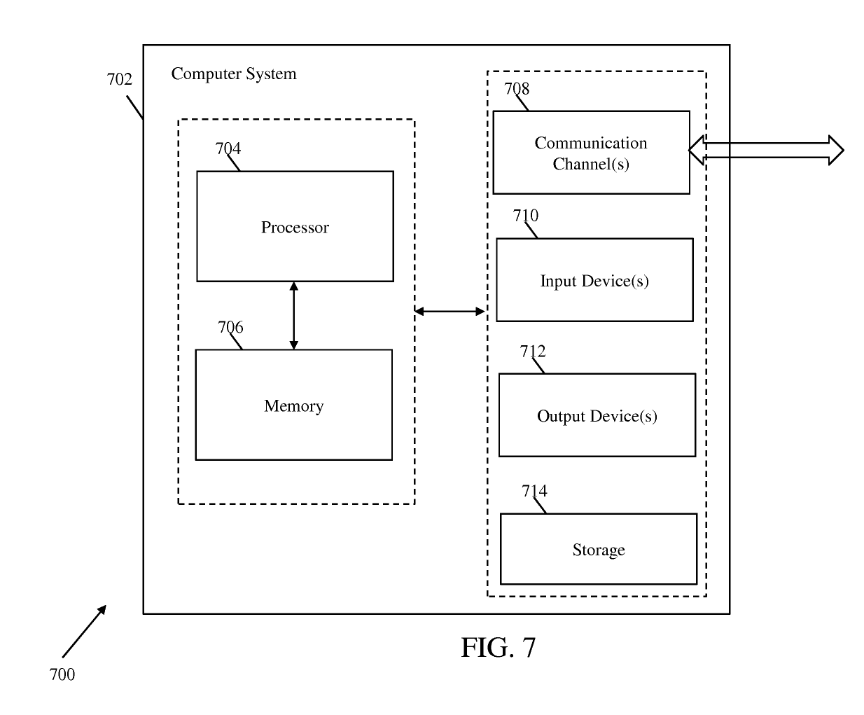

FIG. 7 illustrates an exemplary computer system for projecting one or more interactive images and processing user interaction and gestures, in accordance with an embodiment of the present invention.

The computer system 702 comprises a processor 704 and a memory 706. The processor 704 executes program instructions and may be a real processor. The processor 704 may also be a virtual processor. The computer system 702 is not intended to suggest any limitation as to scope of use or functionality of described embodiments. For example, the computer system 702 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 706 may store software for implementing various embodiments of the present invention. The computer system 702 may have additional components. For example, the computer system 702 includes one or more communication channels 708, one or more input devices 710, one or more output devices 712, and storage 714. An interconnection mechanism (not shown) such as a bus, controller, or network, interconnects the components of the computer system 702. In various embodiments of the present invention, operating system software (not shown) provides an operating environment for various softwares executing in the computer system 702, and manages different functionalities of the components of the computer system 702.

The communication channel(s) 708 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 710 may include, but not limited to, a keyboard, mouse, pen, joystick, trackball, a voice device, a scanning device, or any another device that is capable of providing input to the computer system 702. In an embodiment of the present invention, the input device(s) 710 may be a sound card or similar device that accepts audio input in analog or digital form. The output device(s) 712 may include, but not limited to, a user interface on CRT or LCD, printer, speaker, CD/DVD writer, or any other device that provides output from the computer system 702.

The storage 714 may include, but not limited to, magnetic disks, magnetic tapes, CD-ROMs, CD-RWs, DVDs, flash drives or any other medium which can be used to store information and can be accessed by the computer system 702. In various embodiments of the present invention, the storage 714 contains program instructions for implementing the described embodiments.

The present invention may suitably be embodied as a computer program product for use with the computer system 702. The method described herein is typically implemented as a computer program product, comprising a set of program instructions which is executed by the computer system 702 or any other similar device. The set of program instructions may be a series of computer readable codes stored on a tangible medium, such as a computer readable storage medium (storage 714), for example, diskette, CD-ROM, ROM, flash drives or hard disk, or transmittable to the computer system 702, via a modem or other interface device, over either a tangible medium, including but not limited to optical or analogue communications channel(s) 708. The implementation of the invention as a computer program product may be in an intangible form using wireless techniques, including but not limited to microwave, infrared, bluetooth or other transmission techniques.

These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for projecting one or more interactive images and processing user interaction with the one or more interactive images, the system comprising:
a projector configured to project one or more interactive images on a surface of one or more tables;
a camera configured to sequentially capture a plurality of projected interactive images; and
a processing module configured to detect user interaction by comparing a captured image with a subsequently captured image and further configured to trigger one or more actions associated with the detected user interaction.

2. The system of claim 1 further comprising:
an overhead delivery unit configured to maneuver one or more central projecting devices to the one or more tables, wherein each of the one or more central projecting devices includes the projector, the camera and the processing module; and
one or more inverted telescopic tube assemblies configured to accurately position the one or more maneuvered central projecting devices over the surface of the one or more tables.

3. The system of claim 1, wherein the one or more actions associated with the detected user interaction comprise at least one of: projecting a new interactive image, sending a trigger to a kitchen management system for placing an order and communicating with one or more external systems.

4. The system of claim 1, wherein projecting the one or more interactive images on the surface of the one or more tables comprises:
projecting, on the surface of the one or more tables, a blank image with thin outer boundary, wherein the thin outer boundary has predetermined values of one or more parameters;
capturing the projected blank image by the camera;
locating center of the captured blank image;
positioning origin of a first coordinate system at the bottom left corner of the captured image;
sampling a circle having center as the center of the captured blank image, wherein sampling comprises determining values of one or more parameters of points forming circumference of the circle;
determining if one or more points on the circumference of the circle coincide with the thin outer boundary, wherein if none of the points coincide with the thin outer boundary then another circle having incremented radius is sampled else coordinates of one or more points on the circumference of the circle that coincide with the thin outer boundary are determined with respect to the first coordinate system and then another circle of incremented radius is sampled;
sampling the subsequent circle having center as the center of the captured blank image, wherein sampling comprises determining values of one or more parameters of points forming circumference of the subsequent circle;
determining coordinates of one or more points on the circumference of the subsequent circle that coincide with the thin outer boundary;
determining coordinates of all the points forming the thin outer boundary by sampling plurality of circles with incremented radiuses having center as the center of the captured blank image;
aligning an application coordinate system with the first coordinate system by positioning origin of the application coordinate system at the bottom left corner of projection boundary formed using the determined coordinates; and
projecting one or more interactive User Interface (UI) elements and non-interactive areas within the projection boundary with respect to the aligned application coordinate system.

5. The system of claim 4, wherein the placement and shape of the one or more interactive UI elements and non-interactive areas are pre-stored as at least one of: mathematical equations and solution boundaries with respect to the application coordinate system.

6. The system of claim 4, wherein the values of the determined one or more parameters of each point forming circumference of the circle are compared with the corresponding predetermined values of one or more parameters of the thin outer boundary for determining if the one or more points on the circumference of the circle coincide with the thin outer boundary.

7. The system of claim 4, wherein the values of the determined one or more parameters of each point forming the circumference of the subsequent circle are compared with the corresponding predetermined one or more parameters of the thin outer boundary of the projected blank image for determining the one or more points on the circumference of the subsequent circle that coincide with the thin outer boundary.

8. The system of claim 4, wherein the one or more parameters comprise at least one of: color, brightness and intensity.

9. The system of claim 4, wherein the radiuses of the plurality of circles being sampled are incremented by one pixel.

10. The system of claim 4, wherein the one or more interactive UI elements are areas within the one or more projected interactive image configured to provide one or more options to one or more users for interacting with the projected interactive image using one or more hand gestures and trigger the one or more actions related to the one or more interactive UI elements.

11. The system of claim 1, wherein detecting user interaction by comparing a captured image with a subsequently captured image comprises:
capturing an image of the projected interactive image using the camera;
identifying each of the one or more interactive UI elements within the captured image;
segmenting each of the identified one or more interactive UI elements into one or more pixels;
determining values of one or more parameters of the one or more pixels associated with the first captured image;
capturing another image of the projected interactive image;
identifying each of the one or more interactive UI elements within the subsequently captured image;
segmenting each of the identified one or more interactive UI elements into one or more pixels;
determining values of one or more parameters of the one or more pixels associated with the subsequently captured image;
comparing the values of the one or more parameters of each pixel associated with the subsequently captured image with the corresponding values of the one or more parameters of corresponding pixel associated with the captured image; and
initiating the one or more actions associated with interactive UI element with which one or more users are interacting if it is determined that there is a difference in the compared values.

12. The system of claim 11, wherein if it is determined that there is no difference in the compared values then the processing module captures another image of the projected interactive image.

13. A computer-implemented method for projecting one or more interactive images and processing user interaction with the projected one or more interactive images, via program instructions stored in a memory and executed by a processor, the computer-implemented method comprising:
projecting one or more interactive images on a surface of one or more tables;
capturing a plurality of projected interactive images;
detecting user interaction by comparing a captured image with a subsequently captured image; and
triggering one or more actions associated with the detected user interaction.

14. The computer-implemented method of claim 13 further comprising:
maneuvering one or more central projecting devices to the one or more tables, wherein the one or more central projecting devices are configured to project the one or more interactive images on the surface of the one or more tables; and
accurately positioning the one or more maneuvered central projecting devices over the surface of the one or more tables.

15. The computer-implemented method of claim 13, wherein the one or more actions associated with the detected user interaction comprise at least one of: projecting a new interactive image, sending a trigger to a kitchen management system for placing an order and communicating with one or more external systems.

16. The computer-implemented method of claim 13, wherein the step of projecting the one or more interactive images on the surface of the one or more tables comprises:
projecting, on the surface of the one or more tables, a blank image with thin outer boundary, wherein the thin outer boundary has predetermined values of one or more parameters;
capturing the projected blank image by the camera;
locating center of the captured blank image;
positioning origin of a first coordinate system at the bottom left corner of the captured image;
sampling a circle having center as the center of the captured blank image, wherein sampling comprises determining values of one or more parameters of points forming circumference of the circle;
determining if one or more points on the circumference of the circle coincide with the thin outer boundary, wherein if none of the points coincide with the thin outer boundary then another circle having incremented radius is sampled else coordinates of one or more points on the circumference of the circle that coincide with the thin outer boundary are determined with respect to the first coordinate system and then another circle of incremented radius is sampled;
sampling the subsequent circle having center as the center of the captured blank image, wherein sampling comprises determining values of one or more parameters of points forming circumference of the subsequent circle;
determining coordinates of one or more points on the circumference of the subsequent circle that coincide with the thin outer boundary;
determining coordinates of all the points forming the thin outer boundary by sampling plurality of circles with incremented radiuses having center as the center of the captured blank image;
aligning an application coordinate system with the first coordinate system by positioning origin of the application coordinate system at the bottom left corner of projection boundary formed using the determined coordinates; and
projecting one or more interactive User Interface (UI) elements and non-interactive areas within the projection boundary with respect to the aligned application coordinate system.

17. The computer-implemented method of claim 16, wherein the placement and shape of the one or more interactive UI elements and non-interactive areas are pre-stored as at least one of: mathematical equations and solution boundaries with respect to the application coordinate system.

18. The computer-implemented method of claim 16, wherein the values of the determined one or more parameters of each point forming circumference of the circle are compared with the corresponding predetermined values of one or more parameters of the thin outer boundary for determining if the one or more points on the circumference of the circle coincide with the thin outer boundary.

19. The computer-implemented method of claim 16, wherein the values of the determined one or more parameters of each point forming the circumference of the subsequent circle are compared with the corresponding predetermined one or more parameters of the thin outer boundary of the projected blank image for determining the one or more points on the circumference of the subsequent circle that coincide with the thin outer boundary.

20. The computer-implemented method of claim 16, wherein the one or more parameters comprise at least one of: color, brightness and intensity.

21. The computer-implemented method of claim 16, wherein the radiuses of the plurality of circles being sampled are incremented by one pixel.

22. The computer-implemented method of claim 16, wherein the one or more interactive UI elements are areas within the one or more projected interactive image configured to provide one or more options to one or more users for interacting with the projected interactive image using one or more hand gestures and trigger the one or more actions related to the one or more interactive UI elements.

23. The computer-implemented method of claim 13, wherein projecting the one or more interactive images on the surface of the one or more tables comprises:
projecting, on the surface of the one or more tables, a blank image with thin outer boundary, wherein the thin outer boundary has predetermined values of one or more parameters;
capturing the projected blank image by the camera;
locating center of the captured blank image;
positioning origin of a first coordinate system at the bottom left corner of the captured image;
sampling a circle having center as the center of the captured blank image, wherein sampling comprises determining values of one or more parameters of points forming circumference of the circle;
compute an average value of each of the one or more parameters of the circle;
sampling another circle having center as the center of the captured blank image, wherein sampling comprises determining values of one or more parameters of points forming circumference of the subsequent circle;
compute an average value of each of the one or more parameters of the subsequent circle;
compare the average value of the one or more parameters of the subsequent circle with the corresponding average value of the one or more parameters of the circle, wherein if there is no difference between the compared values then another circle having incremented radius is sampled else if there is a difference between the compared values then coordinates of one or more points on the subsequent circle's circumference that coincide with the thin outer boundary of the projected blank image are determined;
determining coordinates of all points forming the thin outer boundary by sampling plurality of circles with incremented radiuses having center as the center of the captured blank image;
aligning an application coordinate system with the first coordinate system by positioning origin of the application coordinate system at the bottom left corner of projection boundary formed using the determined coordinates; and
projecting one or more interactive User Interface (UI) elements and non-interactive areas within the projection boundary with respect to the aligned application coordinate system.

24. The computer-implemented method of claim 23, wherein the one or more points coinciding with the thin outer boundary of the projected blank image are determined by comparing the values of the one or more parameters of each of the one or more points of the subsequent circle's circumference with the average values of the one or more parameters of the circle, wherein the values of the one or more parameters of each of the one or more points of the subsequent circle's circumference that coincide with the thin outer boundary deviate from the average values of the corresponding one or more parameters of the circle which is fully enclosed within the thin outer boundary.

25. The computer-implemented method of claim 13, wherein the step of detecting user interaction by comparing the captured image with the subsequently captured image comprises:
capturing an image of the projected interactive image using the camera;
identifying each of the one or more interactive UI elements within the captured image;
segmenting each of the identified one or more interactive UI elements into one or more pixels;
determining values of one or more parameters of the one or more pixels associated with the first captured image;
capturing another image of the projected interactive image;
identifying each of the one or more interactive UI elements within the subsequently captured image;
segmenting each of the identified one or more interactive UI elements into one or more pixels;
determining values of one or more parameters of the one or more pixels associated with the subsequently captured image;
comparing the values of the one or more parameters of each pixel associated with the subsequently captured image with the corresponding values of the one or more parameters of corresponding pixel associated with the first captured image; and
initiating the one or more actions associated with interactive UI element with which one or more users are interacting if it is determined that there is a difference in the compared values.

26. The computer-implemented method of claim 25, wherein if it is determined that there is no difference in the compared values then the processing module captures another image of the projected interactive image.

27. A computer program product for projecting one or more interactive images and processing user interaction with the one or more interactive images, the computer program product comprising:
a non-transitory computer-readable medium having computer-readable program code stored thereon, the computer-readable program code comprising instructions that when executed by a processor, cause the processor to:
project one or more interactive images on a surface of one or more tables;
capture a plurality of projected interactive images;
detect user interaction by comparing a captured image with a subsequently captured image; and
trigger one or more actions associated with the detected user interaction.

28. The computer program product of claim 27, wherein the step of projecting the one or more interactive images on the surface of the one or more tables comprises:
projecting, on the surface of the one or more tables, a blank image with thin outer boundary, wherein the thin outer boundary has predetermined values of one or more parameters;
capturing the projected blank image by the camera;
locating center of the captured blank image;
positioning origin of a first coordinate system at the bottom left corner of the captured image;
sampling a circle having center as the center of the captured blank image, wherein sampling comprises determining values of one or more parameters of points forming circumference of the circle;
determining if one or more points on the circumference of the circle coincide with the thin outer boundary, wherein if none of the points coincide with the thin outer boundary then another circle having incremented radius is sampled else coordinates of one or more points on the circumference of the circle that coincide with the thin outer boundary are determined with respect to the first coordinate system and then another circle of incremented radius is sampled;
sampling the subsequent circle having center as the center of the captured blank image, wherein sampling comprises determining values of one or more parameters of points forming circumference of the subsequent circle;
determining coordinates of one or more points on the circumference of the subsequent circle that coincide with the thin outer boundary;
determining coordinates of all the points forming the thin outer boundary by sampling plurality of circles with incremented radiuses having center as the center of the captured blank image;
aligning an application coordinate system with the first coordinate system by positioning origin of the application coordinate system at the bottom left corner of projection boundary formed using the determined coordinates; and
projecting one or more interactive User Interface (UI) elements and non-interactive areas within the projection boundary with respect to the aligned application coordinate system.

29. The computer program product of claim 27, wherein projecting the one or more interactive images on the surface of the one or more tables comprises:
projecting, on the surface of the one or more tables, a blank image with thin outer boundary, wherein the thin outer boundary has predetermined values of one or more parameters;
capturing the projected blank image by the camera;
locating center of the captured blank image;
positioning origin of a first coordinate system at the bottom left corner of the captured image;
sampling a circle having center as the center of the captured blank image, wherein sampling comprises determining values of one or more parameters of points forming circumference of the circle;
compute an average value of each of the one or more parameters of the circle;
sampling another circle having center as the center of the captured blank image, wherein sampling comprises determining values of one or more parameters of points forming circumference of the subsequent circle;
compute an average value of each of the one or more parameters of the subsequent circle;
compare the average value of the one or more parameters of the subsequent circle with the corresponding average value of the one or more parameters of the circle, wherein if there is no difference between the compared values then another circle having incremented radius is sampled else if there is a difference between the compared values then coordinates of one or more points on the subsequent circle's circumference that coincide with the thin outer boundary of the projected blank image are determined;
determining coordinates of all points forming the thin outer boundary by sampling plurality of circles with incremented radiuses having center as the center of the captured blank image;
aligning an application coordinate system with the first coordinate system by positioning origin of the application coordinate system at the bottom left corner of projection boundary formed using the determined coordinates; and
projecting one or more interactive User Interface (UI) elements and non-interactive areas within the projection boundary with respect to the aligned application coordinate system.

30. The computer program product of claim 27, wherein the step of detecting user interaction by comparing the captured image with the subsequently captured image comprises:
capturing an image of the projected interactive image using the camera;
identifying each of the one or more interactive UI elements within the captured image;
segmenting each of the identified one or more interactive UI elements into one or more pixels;
determining values of one or more parameters of the one or more pixels associated with the first captured image;
capturing another image of the projected interactive image;
identifying each of the one or more interactive UI elements within the subsequently captured image;
segmenting each of the identified one or more interactive UI elements into one or more pixels;
determining values of one or more parameters of the one or more pixels associated with the subsequently captured image;
comparing the values of the one or more parameters of each pixel associated with the subsequently captured image with the corresponding values of the one or more parameters of corresponding pixel associated with the first captured image; and
initiating the one or more actions associated with interactive UI element with which one or more users are interacting if it is determined that there is a difference in the compared values.
